(19) United States
(12) Patent Application Publication
(10) Pub. No.: US 2024/0425260 A1
(43) Pub. Date: Dec. 26, 2024

(54) CONTAINER WITH DEPLOYABLE CUSHIONING SHEET AND METHOD OF PACKAGING AN OBJECT

(71) Applicant: 3M INNOVATIVE PROPERTIES COMPANY, St. Paul, MN (US)

(72) Inventors: Sithya S. Khieu, Eden Prairie, MN (US); Thomas R. Corrigan, St. Paul, MN (US); Ignatius A. Kadoma, Cottage Grove, MN (US); Yaohua Gao, Woodbury, MN (US); Stephen M. Sanocki, Stillwater, MN (US); Delony L. Langer-Anderson, Hugo, MN (US); Satinder K. Nayar, Woodbury, MN (US); Gene B. Portelli, Lake Elmo, MN (US); Kimberly C.M. Schultz, Woodbury, MN (US); Annabelle Watts, Minneapolis, MN (US); Manoj Nirmal, St. Paul, MN (US); Patrick R. Fleming, Lake Elmo, MN (US)

(21) Appl. No.: 18/274,035

(22) PCT Filed: Jan. 12, 2022
(86) PCT No.: PCT/IB2022/050211

§ 371 Date: Jul. 25, 2023

Related U.S. Application Data
(60) Provisional application No. 63/143,058, filed on Jan. 29, 2021.

(51) Int. Cl. B65D 81/03; B32B 3/30; B32B 5/18; B32B 7/06; B32B 7/12; B32B 29/00; B65D 65/40

(52) U.S. Cl. CPC B65D 81/03; B32B 3/30; B32B 5/18; B32B 7/06; B32B 7/12; B32B 29/007; B65D 65/403; B32B 2439/06

(57) ABSTRACT

Containers (100), for example boxes, envelopes, mailers, and the like containing one or more deployable cushioning sheets (1500) are disclosed. The deployable cushioning sheets (1500) are connected to at least one wall of the containers (100) and can be deployed to be partially outside of the container for cushioning, for example by wrapping, an object (1600) to be packaged. The deployable cushioning sheets (1500) can contain, for example, paper, cardboard, foam, bubble film, or the like, or they can contain combinations of different types of materials. The containers (100) are useful in methods of packaging, storing, and shipping, among other uses.

### BACKGROUND

Pulp and paper products, such as cardboard, which can be used as packaging materials are known. Conformable packaging sheets are available under the trade designation Flex and Seal from 3M Company (St. Paul, Minnesota, USA). Packaging products that contain cushioning constructions, such as bubble wrapping, are commercially available under the trade designation BUBBLE WRAP, as well as under other brands and labels.

### BRIEF DESCRIPTION OF THE DRAWINGS

FIG. 1 is a side view of a mailer;

FIG. 2 is a three quarter view of a mailer;

FIG. 3 is a three quarter view of a box;

FIGS. 4A-F are photographs of structured sheets with patterned foam;

FIGS. 5A-5E are views of tension activated expandable sheets;

FIG. 6A is a front view of a mailer with a deployable cushioning sheet;

FIG. 6B is a cut-away side view of the mailer of 6A with the deployable cushioning sheet in a first, non-deployed position;

FIG. 6C is a cut-away side view of the mailer of 6A in use with the deployable cushioning sheet in a second, deployed position;

FIG. 6D is a cut-away side view of the mailer of 6A in use with the deployable cushioning sheet wrapped around an object and returned to the interior of the mailer;

FIG. 7 is a cut-away side view of a mailer with a deployable cushioning sheet that is attached to the interior surfaces of two walls of the mailer;

FIG. 8A is a top view line drawing of a slit pattern of deployable cushioning sheet used in illustrative examples 1A, 1C, 1E, 1G, 1I, 2A, 2C, 2E, 2G, 2I, 3A, 3C, 4A, and 4C of the current invention;

FIG. 8B is a top view line drawing of a slit pattern of deployable cushioning sheet used in illustrative examples 1B, 1D, 1F, 1H, 1J, 2B, 2D, 2F, 2H, 2J, 3B, 3D, 4B, and 4D of the current invention;

FIG. 9 is a schematic side view of illustrative examples 1C, 1D, 2C, and 2D of the current invention;

FIG. 10 is a schematic side view of illustrative examples 3A, 3B, 4A and 4B of the current invention; and

FIGS. 11A-11G are photographs showing steps for constructing of a container for Examples 5A-5D.

### DETAILED DESCRIPTION

Throughout this disclosure, singular forms such as “a,” “an,” and “the” are often used for convenience; however, the singular forms are meant to include the plural unless the singular alone is explicitly specified or is clearly indicated by the context. When the singular alone is called for, the term “one and only one” is typically used.

Some terms in this disclosure are defined below. Other terms will be familiar to the person of skill in the art and should be afforded the meaning that a person of ordinary skill in the art would have ascribed to them.

Terms indicating a high frequency, such as (but not limited to) “common,” “typical,” and “usual,” as well as “commonly,” “typically,” and “usually” are used herein to refer to features that are often employed in the invention and, unless specifically used with reference to the prior art, are not intended to mean that the features are present in the prior art, much less that those features are common, usual, or typical in the prior art.

Throughout this disclosure, singular forms such as “a,” “an,” and “the” are often used for convenience; however, the singular forms are meant to include the plural unless the singular alone is explicitly specified or is clearly indicated by the context. When the singular alone is called for, the term “one and only one” is typically used.

Some terms in this disclosure are defined below. Other terms will be familiar to the person of skill in the art and should be afforded the meaning that a person of ordinary skill in the art would have ascribed to them.

Terms indicating a high frequency, such as (but not limited to) “common,” “typical,” and “usual,” as well as “commonly,” “typically,” and “usually” are used herein to refer to features that are often employed in the invention and, unless specifically used with reference to the prior art, are not intended to mean that the features are present in the prior art, much less that those features are common, usual, or typical in the prior art.

The term “compostable” refers to materials, compositions, or articles that meet the ASTM D6400 standard, the ASTM D6868 standard, or both the ASTM D6400 standard and the ASTM D6868 standard. In addition, to meeting the ASTM D6400 or ASTM D6868 standard, compostable materials, compositions, or articles can optionally meet the ASTMD5338 standard. In addition, to meeting the ASTM D6400 or ASTM D6868 standard, compostable materials, compositions, or articles can optionally meet one or more of the EN 12432, AS 4736, or ISO 17088 standards. In addition, to meeting the ASTM D6400 or ASTM D6868 standard, compostable materials, compositions, or articles can optionally meet the ISO 14855 standard. The term “compostable” as used herein is not interchangeable with the term “biodegradable.” Something that is “compostable” must degrade within the time specified by the above standard or standards into materials having a toxicity, particularly plant toxicity, that conform with the above standard or standards. The term “biodegradable” does not specify the time in which a material must degrade, nor does it specify that the compounds into which it degrades pass any standard for toxicity or lack of harm to the environment. For example, materials that meet the ASTM D6400 standard must pass the test specified in ISO 17088, which addresses “the presence of high levels of regulated metals and other harmful components,” whereas a material that is “biodegradable” may have any level of harmful components.

The term “independently” when used in reference to variables means that the identity of one variable bears no relation to the identity of another. For example, if each variable X in item X-X is independently chosen from A and B, then X-X may be A-A, A-B, B-A, or B-B.

“Paper” as used herein refers to woven or non-woven sheet-shaped products or fabrics (which may be folded, and may be of various thicknesses) made from cellulose (particularly fibers of cellulose, whether naturally or artificially derived) or otherwise derivable from the pulp of plant sources such as wood, corn, grass, rice, and the like. Paper includes products made from both traditional and non-traditional paper making processes, as well as materials of the type described above that have other types of fibers embedded in the sheet, for example, reinforcement fibers. Paper may have coatings on the sheet or on the fibers themselves. Examples of non-traditional products that are “paper” within the context of this disclosure include the material available under the trade designation TRINGA available from PAPTIC (Espoo, Finland), and sheet forms of the material available under the trade designation SULAPAC.

The term “recyclable” refers to materials, compositions, or articles that meet at least one of the Voluntary Standard for Repulping and Recycling Corrugated Fiberboard as promulgated by the Fibre Box Association (FBA) part 1 (repulpability), Voluntary Standard for Repulping and Recycling Corrugated Fiberboard as promulgated by the Fibre Box Association (FBA) part 2 (recyclability), and ISO 18601 standards. Particular recyclable items meet the Voluntary Standard for Repulping and Recycling Corrugated Fiberboard part 1 (repulpability). Particular recyclable items meet the Voluntary Standard for Repulping and Recycling Corrugated Fiberboard part 2 (recyclability). More particular recyclable items meet the Voluntary Standard for Repulping and Recycling Corrugated Fiberboard part 1 (repulpability) and part 2 (recyclability). Still more particularly, recyclable items meet the Voluntary Standard for Repulping and Recycling Corrugated Fiberboard part 1 (repulpability) and part 2 (recyclability) standards, as well as the ISO 18601 standard. Even more particularly, recyclable items additionally meet the ISO 18604:2013 standard. All references to the Voluntary Standard for Repulping and Recycling Corrugated Fiberboard standard, whether to part 1, part 2, or both, refer to the 2013 version of the standard. It should be noted that a recyclable material may include materials, such as adhesives, that do not meet one or more of the above standards. This is because materials, particularly adhesives, are commonly removed from paper products during the recycling process. Such materials, especially adhesives, that are not themselves recyclable but are readily removed from a product during the recycling process are referred to herein as “recycle-compatible.”A “recyclable” article thus may contain both components that meet the definition of recyclable as well as components that are recycle-compatible but o not meet the definition of recyclable. A typical example of such an article is a paper mailer made from recyclable paper but having a non-recyclable tape adhered to the paper; such an article meets the definition of recyclable because the non-recyclable tape would be removed during the repulping portion of recycling process.

In the packaging field, it is known to provide containers with cushioning components or padding. Examples include envelopes, mailers, and the like, with cushioning components, such as air-filled bubbles, built into one or more walls of the envelope of mailer. This disclosure recognizes several problems with known containers used for packaging, particularly relating to their approach to cushioning. Known containers do not offer customizable cushioning that can be adapted to the item or items to be packaged and protected by the cushioning. For example, envelopes with air-bubble padding have padding along one or more walls of the envelope, but these cannot be adapted to the particular object being placed in the envelope. Boxes with fragile items, such as cellular phones, will typically have a molded plastic carrier that is custom fitted for the item (such as a cellular phone) to be packaged, but the molded plastic carrier is essentially useless any item having a shape other than the one for which the plastic is custom fitted. As such, the present disclosure recognizes the lack of a customizable cushioning solution. More specifically, this disclosure recognizes the lack of containers that include a customizable cushioning solution as part of the container. Packaging peanuts and similar void fillers are not truly customizable. They retain their shape and do not conform or adapt to the shape of the object being packaged. Thus, another problem is the lack of a container having a conformable cushioning solution, and particularly one that is part of the container itself.

Yet another problem with known cushioned packaging material, such as mailers, is that they are voluminous because the cushioning components, such as bubble film or foam, take up a lot of space. Because shipping costs increase with increased weight and volume, more voluminous mailers cost more money to ship to the location of their intended use or point of sale as compared to less voluminous mailers, and they take up a lot of space when in storage or on a store shelf. When in use, they can add to the expense of shipping an item for the same reason. Thus, between the time of manufacture and the time they are finished being used (e.g., when they have been used to ship a product to its final destination), previously known mailers with cushioning components are shipped at least twice (from factory to point of sale and then to end destination with an article enclosed). Each time, a significant volume of the shipment is air. So the cost of previously known mailers is increased because it is necessary to ship a large quantity air to get them to their point of sale.

Briefly, a solution to these and other problems lies in a container having a container interior that is at least partially defined by a first wall comprising a first wall interior major surface and opposing first wall exterior major surface, and a second wall comprising a second wall interior major surface and opposing second wall exterior major surface. The container comprises one or more deployable cushioning sheets connected to the first wall interior major surface. The one or more deployable cushioning sheets have a length and are configured to be deployable from a first position, wherein a first portion of the length of the one or more deployable cushioning sheets is disposed within the container interior and an optional second portion of the length of the one or more deployable cushioning sheets is disposed outside the container interior, and second position wherein at least part of the first portion of the length is disposed outside of the container. The solution may also lie in a method of packaging an object that includes deploying at least one of the deployable cushioning sheets of the aforementioned container, contacting the at least one of the deployable cushioning sheets with the object, and placing the at least one of the one or more deployable cushioning sheets with the contacted object in the container interior. Details of various implementations of these solutions are described herein, but the scope of protection sought is defined only by the claims.

### Containers

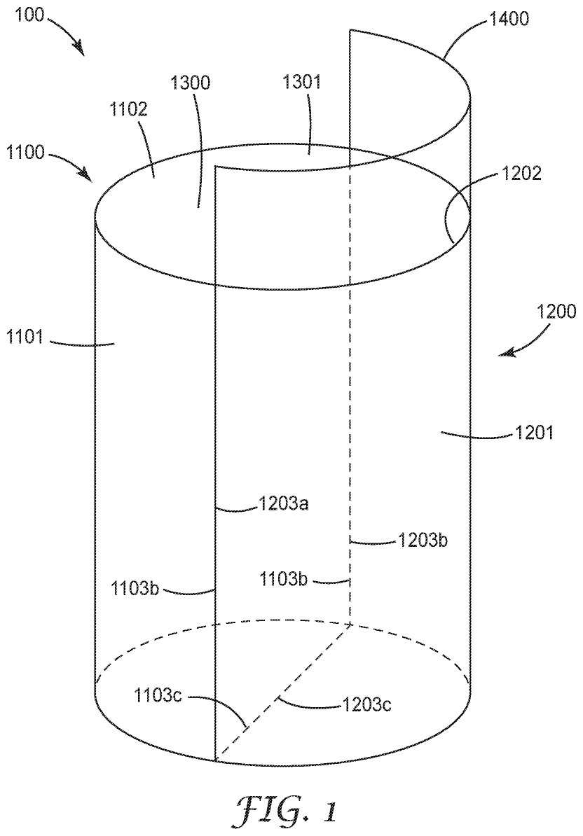

A variety of types of containers may be employed, for example envelopes, mailers, and boxes. Envelopes or mailers may be flat, but this is not required. Boxes are typically cube shaped but may also be shaped as tubes or in other shapes. Some exemplary types of containers with which a deployable cushioning sheet can be used are initially described in this portion of the disclosure, where for clarity they are shown without the deployable cushioning sheet. Any of the exemplary containers that are described, as well as other containers, may be employed with any of the exemplary deployable cushioning sheets, or with other deployable cushioning sheets, unless otherwise indicated. One example, shown in FIG. 1, is container 100, which is an envelope or mailer and featuring first wall 1100 having first wall interior major surface 1102 and opposing first wall exterior major surface 1101, as well as second wall 1200 having second wall interior major surface 1202 and opposing second wall exterior major surface 1201. First wall 1100 has three edges 1103a, 1103b, 1103c, and second wall 1200 has three edges 1203a, 1203b, 1203c, which are connected to the corresponding edges of first wall 1100 such that first wall interior major surface 1102 faces second wall interior major surface 1202 and the space between first wall 1100 and second wall 1200 defines a container interior 1300 and opening 1301. Flap 1400 is positionable so that it can cover at least a portion of opening 1301 to close container 100.

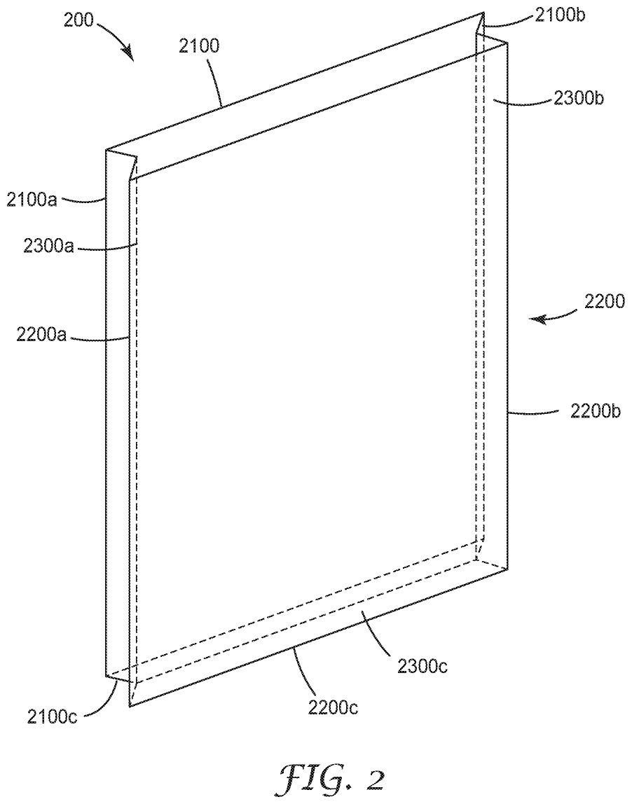

Another example, as shown in FIG. 2, is container 200, which in the form of an envelope or mailer that features first wall 2100 and opposing second wall 2200. Edges 2100a, 2100b, 2100c of first wall 2100 are connected to edges 2200a, 2200b, 2200c of second wall 2200 by way of gussets 2300a, 2300b, 2300c. In this FIG. 2, there are three gussets, one for each of the pairs of connected edges, but it is also possible to include only two or one gusset (in which case one or two of the pairs of connected edges will not be connected by a gusset), or to include a multiple gusset, such as a double or triple gusset, to connect one or more of the pairs of connected edges. The gussets can be made of the same or different materials than the walls that they connect.

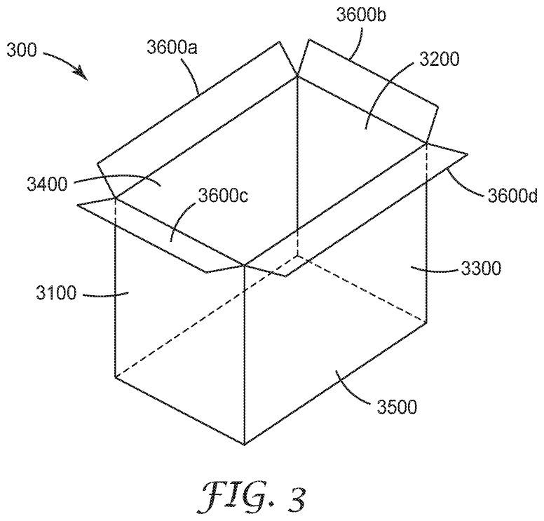

Container 300 depicted in FIG. 3 is a box, having first wall 3100 and opposing second wall 3200, each of which is connected to third wall 3300 and fourth wall 3400; all four walls are connected to bottom 3500. Flaps 3600a, 3600b, 3600c, 3600d can be positioned to close box 300.

### Walls

Any of the walls of any of the containers may be made from any suitable material or materials, for example, any of the exemplary materials or constructions described in this section.

Any suitable material can be used for the first wall, the second wall, or both; the same materials can be used for the third wall, fourth wall, flaps, and bottom, in cases where any of those are employed. Suitable materials include those that can be bent, folded, or otherwise shaped such that the sheet article can be made into a packaging article or packaging construction as described herein. The material that constitutes the first wall, second wall, or both, and when employed one or more of the third wall, fourth wall, flaps, and bottom, can comprise a compostable material, a recyclable material, or a material that is both compostable and recyclable. The first wall and the second wall, and when employed one or more of the third wall, fourth wall, flaps, and bottom, are most commonly made from the same material or materials, but this is not necessary; for some applications it may be beneficial to make the first and second walls, and when employed one or more of the third wall, fourth wall, flaps, and bottom, from different materials. For some applications, thermoplastic materials can be particularly useful for the first wall, second wall, or both, however this is not required and materials that are not thermoplastic can also be employed.

Particularly, the material that constitutes the first wall, second wall, or both, and when employed one or more of the third wall, fourth wall, flaps, and bottom, comprises a material that is independently selected from one or more of poly(lactic acid) (which is sometimes known as PLA, and as used herein is intended to encompass both poly(lactic acid) and poly(lactide)), poly(glycolic acid) (which as used herein is intended to encompass both poly(glycolic acid) and poly(glycolide)), poly(caprolactone), poly(lactide-co-glycolide), copolymers of two or more of lactic acid, glycolic acid, and caprolactone, polyhydroxyalkanoate, polyester urethane, degradable aliphatic-aromatic copolymers, poly(hydroxybutyrate), copolymers of hydroxybutyrate and hydroxyvalerate, poly(ester amide), and cellulose. Of the foregoing, poly(lactic acid) and cellulose are most commonly employed.

When a material such as poly(lactic acid), polylactide, poly(glycolic acid), polyglycolide, poly(caprolactone), poly(lactide-co-glycolide), copolymers of two or more of lactic acid, glycolic acid, and caprolactone, polyhydroxyalkanoate, polyester urethane, degradeable aliphatic-aromatic copolymers, poly(hydroxybutyrate), copolymers of hydroxybutyrate and hydroxyvalerate, or poly(ester amide), particularly poly(lactic acid), polylactide, poly(glycolic acid), polyglycolide, poly(caprolactone), poly(lactide-co-glycolide), copolymers of two or more of lactic acid, glycolic acid, or caprolactone, and most particularly poly(lactic acid), is employed as part of the first wall, second wall, or both, it is typically in the form of a nonwoven sheet. Nonwoven sheets of such materials and their manufacture are known in the art. Spun bonding is one particularly useful method of manufacturing nonwoven sheets of such materials, particularly poly(lactic acid). Exemplary spun bonding processes that produce nonwovens useful for the packaging articles described herein are described in U.S. Pat. No. 3,803,817, but other processes may also be employed.

When the material that constitutes the first wall, the second wall, or both, and when employed one or more of the third wall, fourth wall, flaps, and bottom, comprises cellulose, the material is most commonly in the form of paper. Any suitable type of paper can be used, examples include Kraft paper, bond paper, and creped paper. Corrugated paper such as cardboard can also be used for one or more of the first wall and second wall, and when employed, the one or more of third wall, fourth wall, bottom, and flaps.

The material that constitutes the first wall, second wall, or both, and when employed one or more of the third wall, fourth wall, flaps, and bottom, is typically the form of a sheet. Particular nonwoven sheets that can be used have a basis weight that is sufficient to allow them to withstand weather conditions, such as heat, cold, rain, or snow, and other conditions and that may be encountered during a packaging and shipping process, as well as to withstand handling that may occur during packaging and shipping, such as dropping, jostling, banging against other objects, and the like.

Another particularly useful material that can be employed in the first wall, the second wall, or both, and when employed one or more of the third wall, fourth wall, flaps, and bottom, is cellulose. When used, the cellulose is typically a component of paper. Any form of paper can be employed in the first wall, the second wall, or both, as long as it is compostable. Kraft paper, bond paper, and crepe paper are exemplary papers that can be employed. Kraft paper is particularly useful.

The first wall, second wall, or both, and when employed one or more of the third wall, fourth wall, flaps, and bottom, may be constructed from a single layer or sheet of material or from multiple sheets. When a single layer or sheet is used, it is typically either PLA or paper.

For any of the walls, the sheet or sheets used can be of any suitable basis weight. A variety of basis weights may be suitable depending on the needs of the users. Most commonly, the basis weight in units of g/m² (grams per square meter) is be no less than 20, optionally no less than 30, optionally no less than 40, optionally no less than 50, optionally no less than 75, optionally no less than 100, optionally no less than 125, optionally no less than 150, optionally no less than 175, optionally no less than 200, optionally no less than 225, or optionally no less than 250. The basis weight (again in units of g/m²) is typically no greater than 250, optionally no greater than 225, optionally no greater than 200, optionally no greater than 175, optionally no greater than 150, optionally no greater than 125, optionally no greater than 100, optionally no greater than 75, optionally no greater than 50, optionally no greater than 40, or optionally no greater than 30. As an example the basis weight (again in units of g/m²) can be 20-250, more particularly the basis weight for nonwovens that are used can be 20-100 for nonwoven, and more particularly the basis weight for a cellulose-based wall can be 50-250.

When more than one sheet or layer is used for the first wall, second wall, or both, and when employed one or more of the third wall, fourth wall, flaps, and bottom, the sheets or layers can be bound together in any suitable way. Examples include a conductive, convective, radiative, inductive, resistive, or frictional form of heating. When the coatings are heat-sealable coatings, the layers or sheets can be bonded together by a heat-sealing process, such as impulse sealing. Ultrasonic welding can also be used. The adjoining sides of the sheets or layers can have adhesive which can be used to adhere the layers or sheets, for example, when the adhesive is a pressure sensitive adhesive then pressure can be used to bond the sheets or layers. A patterned calendar roll can also be used.

### Coatings

The first wall and second wall can advantageously have a sealable coating disposed over at least one surface of the first wall, second wall, or both, and when employed one or more of the third wall, fourth wall, flaps, and bottom. The coating may be disposed over less than all of such surface or surfaces but is most commonly disposed over the entire surface.

Most commonly, the sealable coating is disposed on at least one surface of the first wall and at least one surface of the second wall, and particularly it is disposed on the interior surface of the first wall, the interior surface of the second wall, or the interior surfaces of both the first and second wall. In addition, or in the alternative, the sealable coating can be disposed on the exterior surface of the first wall, the exterior surface of the second wall, or the exterior surfaces of both the first wall and the second wall. Particularly, the sealable coating is disposed on both the interior and the exterior of both the first and second walls.

The sealable coating can serve several purposes. It can be useful in forming the packaging article by allowing the edge or edges where the first wall is attached to the second wall to be heat sealed. It can also serve to provide weather or water resistance to the packaging article. Further, it can play a function in the channels' ability to retain air once they are closed.

The sealable coating typically comprises one or more of poly(butylene succinate), poly (butylene succinate adipate), poly(ethylene succinate), poly(tetramethylene adipate-co-terephthalate), castor wax, acrylic, or thermoplastic starch. Particularly, the sealable coating comprises at least one of poly(butylene succinate), poly (butylene succinate adipate), poly(ethylene succinate), castor wax, or poly(tetramethylene adipate-co-terephthalate), or acrylic. More particularly, the coating comprises poly(butylene succinate), castor wax, or both. Also more particularly, the coating can comprise acrylic, such as waterborne acrylic, for example those sold by BASF under the trade designation JONCRYL, such as JONCRYL HPB 4020 and JONCRYL HPB 4030.

Other components can also be included in the sealable coating. Particularly, compostable pigments and dyes can be used. Examples include PLA masterbatch colorings available from Clariant Corp. (Minneapolis, MN, USA) under the OM or OMB lines of products, or those available from Techmer PM LLC (Clinton, TN, USA) under the PLAM or PPM lines of products. Typically, when colorings are employed, they are blended with the other coating components at an amount of 0.5%-5% by weight.

Coatings can be disposed on a layer or sheet of the first wall, second wall, or both by any suitable method. Two methods are particularly important, and either one of them can be used with any embodiment of the article as described herein.

The first particularly important method of applying the coating to the underlying sheet or layer materials after the underlying sheet or layer has been formed. This can be accomplished by any suitable method, such as extrusion, knife coating, gravure coating, curtain coating, die coating, and the like.

The second particularly important method of applying the coating is to coat the individual fibers of the sheet or layer with the coating. This results in a core-sheath configuration with the core as the sheet or layer material (or materials) and the sheath as the coating. In this case, further coatings could in principle be applied to the sheath, and this is within the scope of the coatings as described herein.

It is also possible to use a combination of the foregoing two approaches in any embodiment of the articles described herein. Thus, in particular cases, the individual fibers are coated in a core-sheath type configuration and a coating, which can be the same or different coating from the sheath, is disposed on one or both sides of the layer or sheet of material made from the core-sheath fibers.

In either case, the coating need not be applied to the entirety of the first or second wall but can be on only part of the layer or sheet. More particularly however, the coating is applied to the entirety of at least one side of the layer or sheet. Even more particularly, the coating, and most particularly a coating comprising poly(butylene succinate), is applied to the entirety of both sides of the layer or sheet.

One particularly useful construction for one or more of the layers or sheets is a poly(lactic acid) layer or sheet that is completely coated on both sides with poly(butylene succinate). More particularly, the layers or sheets having a poly(lactic acid) layer or sheet that is completely coated on both sides with poly(butylene succinate) can be embossed. Another particularly useful construction for the layers or sheets is a paper layer or sheet that is completely coated on both sides with poly(butylene succinate). More particularly, the paper layer or sheet that is completely coated on both sides with poly(butylene succinate) can be embossed. In any of the layers or sheets that are completely coated on both sides, and particularly the foregoing poly(lactic acid) or paper layers or sheets that are completely coated on both sides with poly(butylene succinate), the coating can be in the form of a layer disposed on the layer or sheet of material or in the form of a sheath that is disposed on the fibers of the layer or sheet material.

Coating thicknesses, in micrometers, can be any thickness required to provide the desired properties but are typically between greater than 10, greater than 15, greater than 20, greater than 25, greater than 30, greater than 35, greater than 40, greater than 45, or even greater than 50. Coating thicknesses, in micrometers, are typically less than 60, less than 55, less than 50, less than 45, less than 40, less than 35, less than 30, less than 25, or even less than 20. An exemplary range for coating thickness, in micrometers, is 20 to 50; another exemplary range for coating thickness, in micrometers, is 10-20. When the coating is a sheath over a core fiber, the “coating thickness” refers to the thickness of the sheath; when the coating is applied as a layer then it refers to the thickness of the layer.

### Adhesive Portions

In some embodiments, one or more adhesive portions can be provided, for example on an exterior surface of the first or second walls, or if employed the third wall, fourth wall, bottom, or flaps. The adhesive portions are not considered to be part of the first or second walls. If a flap is employed, the one or more adhesive portions are often on the flap, or on a portion of the exterior surface that can be reached by the flap when the flap is folded into the closed position, so as to allow the flap to be adhered into a closed position. In some cases, two adhesive portions are provided.

The one or more adhesive portions are usually in the shape of a strip or strips that runs roughly parallel to the opening of the packaging article, but this is not required.

The one or more adhesive portions can be any suitable adhesive depending on the desired use. In particular cases, the one or more adhesive portions consist of compostable adhesive. The one or more adhesive portions can be a water-activated adhesive or a pressure sensitive adhesive. Most particularly, a compostable pressure sensitive adhesive is employed. Exemplary compostable adhesives are known, and examples include a copolymer of 2-octylacrylate and acrylic acid; a copolymer of sugar-modified acrylates; a blend of poly(lactic acid), polycaprolactone, and resin; a blend of poly(hydroxyalkanoate) and resin; protein adhesive; natural rubber adhesive; and polyamides containing dimer acid.

The one or more adhesive portions can also be double sided tape, in which case one side of the double sided tape can be fixed to the appropriate location or locations on one or more walls. The double sided tape, when employed, can be selected based on the desired properties of the adhesive portion and the intended use. Examples include 9925XL double sided tape (available from 3M Company, St. Paul, MN, USA), double-sided transfer tape, for example, a transfer tape having a polyamide adhesive and dual release liners, as well as those transfer tapes sold under the trade designations 9943XL, 465XL, 9934XL (available from 3M Company, St. Paul, MN, USA).

One or more release liners can be disposed over any or all the one or more adhesive portions. While it is advantageous that the release liners be compostable or at least recyclable, this is not required because the release liners can be disposed of separately from the packaging article after use and do not have to be placed with the packaging article in a composting environment. Thus, if the containers as described herein have one or more release liners, the packaging articles can be “compostable” even if any or all the release liners are not compostable.

### Composability and Recyclability

In most cases, the containers as described herein are compostable, recyclable, or both. When recyclable, the sheet articles typically meet the Voluntary Standard for Repulping and Recycling Corrugated Fiberboard as promulgated by the Fibre Box Association (FBA) part 1 (repulpability). In addition, or in the alternative, containers can meet the Voluntary Standard for Repulping and Recycling Corrugated Fiberboard as promulgated by the Fibre Box Association (FBA) part 2 (recyclability).

Particular recyclable containers also meet the ISO 18601 standard. Particular containers also meet the ISO 18604:2013 standard. Most particularly recyclable containers also meet both the ISO 18601 and the ISO 18604:2013 standards.

The containers may contain some components that are recycle-compatible rather than recyclable, in which case the sheet articles are still considered to be recyclable. It is also possible for the sheet articles to contain components, such as release liners, that are not recyclable but are designed to be removed from the sheet articles before recycling. In such cases, the sheet articles are still considered to be recyclable.

When the containers are compostable, they can meet the ASTM D6400 standard. Additionally, or in the alternative, when the containers are compostable they can mee the ASTM D6868 standard. In addition to meeting one or both of the aforementioned standards, compostable containers can meet at least one of the EN 12432 standard, the AS 4736 standard, or the ISO 17088 standard. Particular compostable containers also meet the ISO 14855 standard.

### Deployable Cushioning Sheet

The deployable cushioning sheet or sheets can be made of any suitable material. Suitable materials include those that are able provide cushioning, impact protection, or crush protection to objects that they contact. Most typically, the deployable cushioning sheet is or comprises paper. The deployable cushioning sheet may also comprise foam components, for example, it can be made primarily of foam or may have foam in addition to other materials such as paper, for example, the deployable cushioning sheet can have foam components adhered to paper. Other types of materials, such as bubble film, can also be used; however, plastic films such as bubble film can be less advantageous in some cases such as when recyclability or compostibility is desired. Regardless of the material, the deployable cushioning sheet or sheets can be one layer of material or they can be multiple layers; when multiple layers are used any of the multiple layers can be the same or different materials.

When paper is used, it may be any type of paper. The most commonly employed papers include bond paper, Kraft paper, and crepe paper, however in principle any type of paper can be used depending on the requirements of the final container.

When any type of paper is employed in the deployable cushioning sheet, the paper particularly includes one or more cushioning elements that can provide impact protection to an object that contacts the deployable cushioning sheet. Any suitable cushioning element may be employed, and the particular cushioning element that is used will depend on the ultimate requirements of the container, which in turn depends on its ultimate intended use.

In one example of a deployable cushioning sheet with cushioning elements, the deployable cushioning sheet is a structured sheet having a plurality of separated surface structures. By “separated surface structures,” it is meant that at least a portion of one or more of the surface structures are separated from at least a portion one or more other surface structures by unstructured portions of the structured sheet. The plurality of separated surface structures may be any type of surface structure. Commonly employed structures include fluted surface structures, corrugated surface structures, pleated surface structures, embossed surface structures, or combinations thereof. The separated surface structures can also be attached to the structured sheet (rather than being integral to the structured sheet), for example, corrugated strips, spheres, foam pieces, or the like can be adhered or otherwise affixed to the structured sheet. It is also possible to use more than one of type of surface structure on the same structured sheet. It is further possible to use a combination of attached separated surface structures and integral separated surface structures, such as foam structures that are attached to an embossed structured sheet.

The separated surface structures of the structured sheet can be arranged irregularly on the sheet, but more particularly they are arranged in a geometric pattern. The geometric pattern typically has a rotational axis of symmetry (i.e., an S axis) Sn, wherein 360/n is the number of degrees by which a rotation or the geometrical pattern about the axis will return a geometrical pattern that is identical to the original. Thus, n=2 indicates a two-fold axis of symmetry wherein a rotation of 180 degrees will return a geometrical pattern identical to the original, n=3 indicates a three-fold axis of symmetry wherein a rotation of 120 degrees will return a geometrical pattern identical to the original (as will subsequent rotations of 120 degrees), etc. When a rotational axis of symmetry Sn is present, typically n is greater than 2 and no greater than 90, particularly n is no greater than 12, more particularly n is 3-6, even more particularly n is 3 or 4, and most particularly n is 3. Alternatively, the geometrical pattern can have an S2 axis of symmetry. It is also possible for the geometric pattern to incorporate multiple types of symmetry. For example, the geometric pattern could feature an array of sets of elements having an S6 axis, wherein the array itself has an S4 axis.

In most cases, each of the plurality of separated surface structures have the same size and shape. However, it is also possible for the plurality of separated surface structures to include a first set of surface structures having a first size and shape as well as a second set of surface structures having a second size and shape.

The structured sheet typically comprises a first major surface and opposing second major surface. In cases where the plurality of separated surface structures includes embossments, typically one of the first and second major surfaces will have protrusions and the other will have recesses. In cases where the plurality of separated surface structures are attached to the structured sheet, they are usually attached to only one of the first major surface or the second major surface; however, it is possible to attach some separated surface structures to both the first and the second major surfaces.

It is also possible for a face sheet to be present, in which case at least some of the plurality of separated surface structures will typically be disposed between the structured sheet and the face sheet. This is a particularly common configuration, for example, when the plurality of separated surface structures include fluted or folded paper, such as in cardboard.

When the plurality of separated surface structures includes a foam, the foam is preferably recyclable, compostable, or both recyclable and compostable. Exemplary foams that can be used include recyclable foams, such as the water-based heat-expandable adhesives disclosed in WO2019040624.

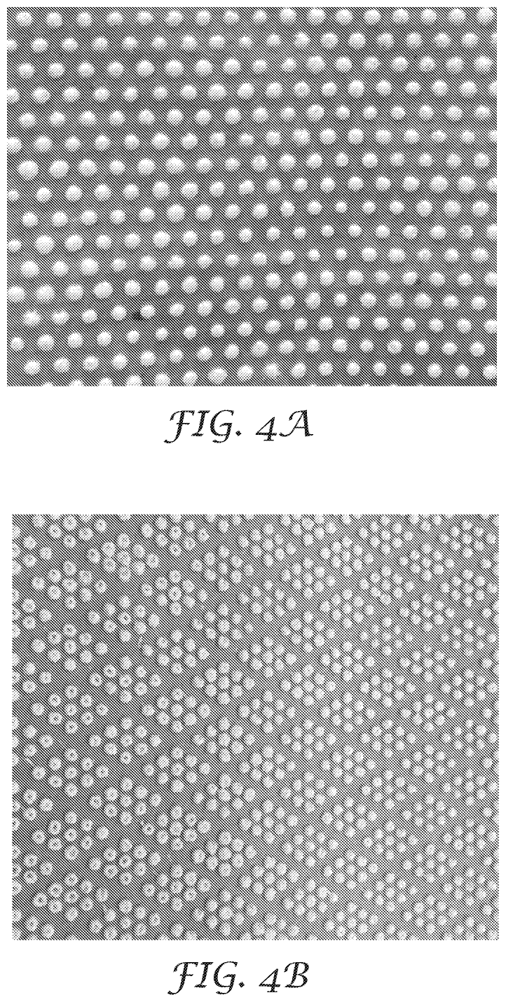

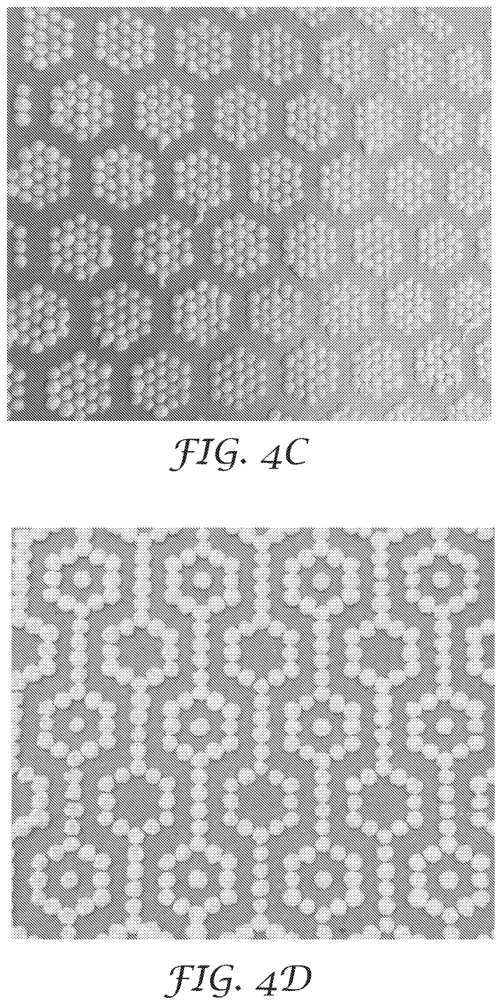

When the separated surface structure includes foam, the foam is most commonly disposed on the deployable cushioning sheet in a repeating pattern. In principle any pattern can be used as separated surface structures. The pattern can be selected depending on the desired use, for example, the type of objects that are intended to be packaged within the container, recognizing that the pliability and cushioning ability may be affected by the pattern chosen and the size of the foam components. The patterns can be formed by any suitable method, such as by screen-printing the foam material onto the paper. Some examples of patterns that can be employed are shown in FIGS. 4A-F

It is possible to use deployable cushioning sheets that do not feature separated surface structures. A particular example of such deployable cushioning sheets is tension activated expandable sheets. Tension activated expandable sheets, which are typically paper but can be made from or include other materials, have a plurality of slits or cuts, typically in one or more repeating patterns. Tension activated expandable sheets are defined by a tension axis and an axis orthogonal to the tension axis. When tension is applied to tension activated expandable sheets, the sheet expands in the direction of the tension axis.

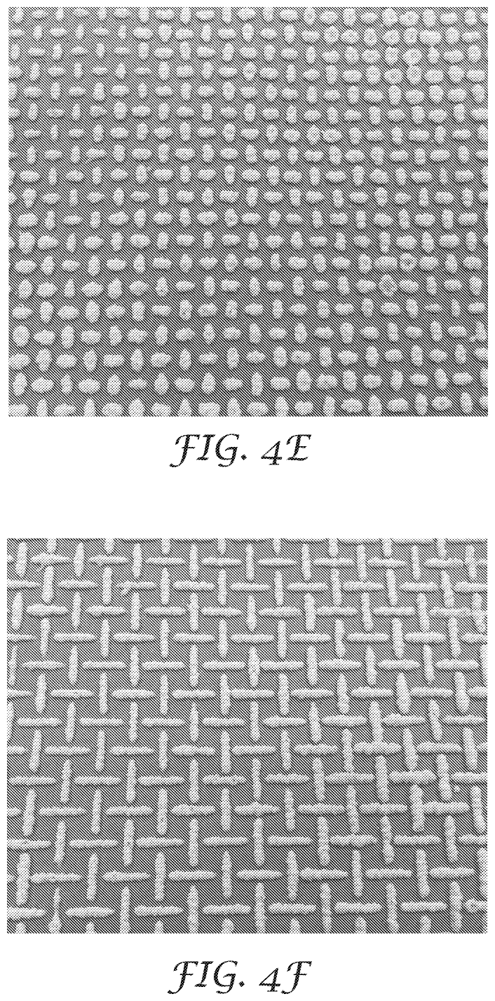

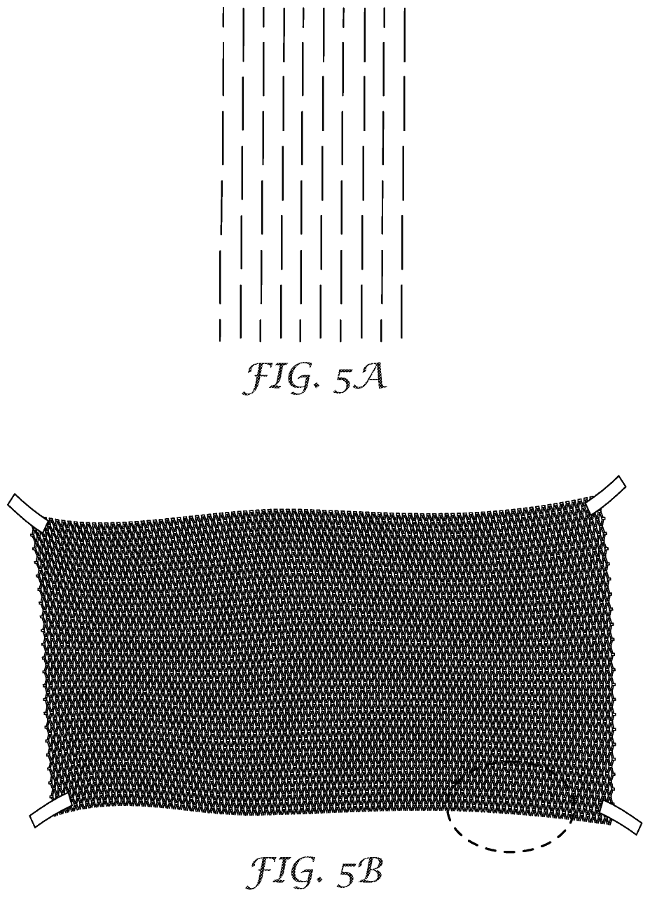

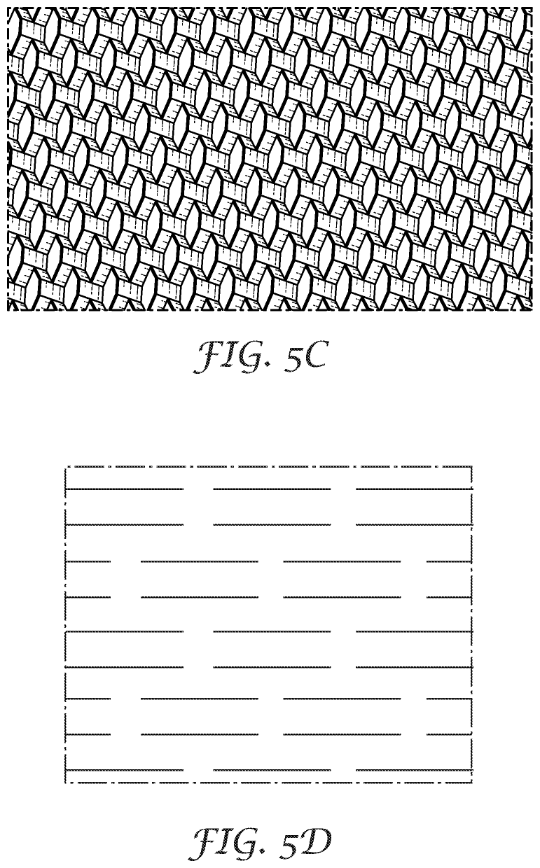

A variety of slit or cut patterns can be used in tension activated expandable sheets. Some examples can be seen in FIGS. 5A-5F. FIG. 5A shows an exemplary tension activated expandable sheet in the non-extended configuration having a tensioning axis T and a plurality of slits 510. FIG. 5B shows the same exemplary tension activated expandable sheet in an extended configuration, after tension has been applied along tensioning axis T; the circumscribed portion of the tension activated expandable sheet shown in FIG. 5B is shown in more detail in FIG. 5C. FIGS. 5D and 5E show, respectively, a different slit pattern in the unextended (5D) and extended (5E) forms. It should be noted that a wide variety of slit patterns are possible, including those where some or all of the slits are curved, have right-angles, or have compound designs (i.e., designs that cannot be drawn with a pencil picking up the pencil) and in practice any of them can be used in a deployable cushioning sheet. The particular slit pattern can depend on the desired properties and intended use of the container. When a tension activated extendible sheet is used as one or more of the deployable cushioning sheets, it is typically in the unextended form to start. The method of use of the container, such as for packaging an object, can involve the step of extending the tension activated extendible sheet and contacting, for example by wrapping, the extended tension activated extendible sheet with an object.

When the deployable sheet is a tension activated expandable sheet, it is typically not extended when it is in the first (undeployed) position. Upon deployment, the tension activated expandable sheet can expand, thus pushing the inner surfaces of the container apart and increasing the distance between them.

Thus, in some embodiments, particularly those that include a tension activated expandable sheet, the there is a first distance between the interior surface of the first wall and the interior surface of the second wall when the deployable cushioning sheet, such as the tension activated expandable sheet, is in the first (not deployed) position and a second distance between the interior surface of the first wall and the interior surface of the second wall when the deployable cushioning sheet, such as the tension activated expandable sheet, is in the second (deployed) position. The second distance is greater than the first distance. The second distance can be, for example, at least 2 times, at least 5 times, at least 10 times, at least 25 times, at least 50 times, at least 75 times, at least 100 times, at least 250 times, at least 500 times, at least 1,000 times, at least 2,000 times, or even at least 5,000 times the first distance. Another example of a deployable cushioning sheet that does not include separated surface structures is a foam sheet. The foam sheet is preferably reasonable pliable or foldable, and can be made from any suitable foam, preferably a recyclable or compostable foam. Examples include the water-based heat-expandable adhesives disclosed in WO2019040624.

Deployable cushioning sheets can include more than one of the foregoing. For example, tension activated extendible sheets can be made of foam rather than paper, or they can contain foam portions attached to them or can have some corrugated portions. Foam deployable cushioning sheets can contain separated surface structures, such as embossments. Other combinations are also possible.

Any deployable cushioning sheet can have a pull tab attached thereto. The pull tab can, for example, extend to the outside of the container when the deployable cushioning sheet is in the first (undeployed) position. The pull tab can facilitate a user moving the deployable cushioning sheet from the first position to the second position. When the deployable cushioning sheet is a tension activated expandable sheet, the pull tab can facilitate expanding the tension activated expandable sheet during deployment of the deployable cushioning sheet.

### Construction

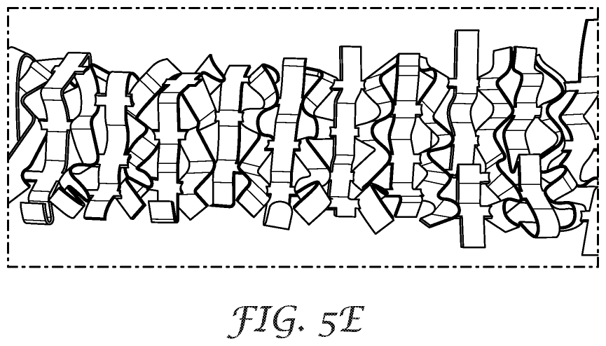

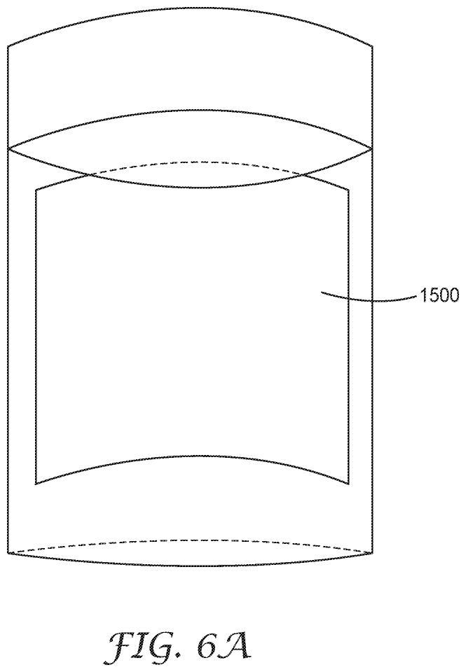

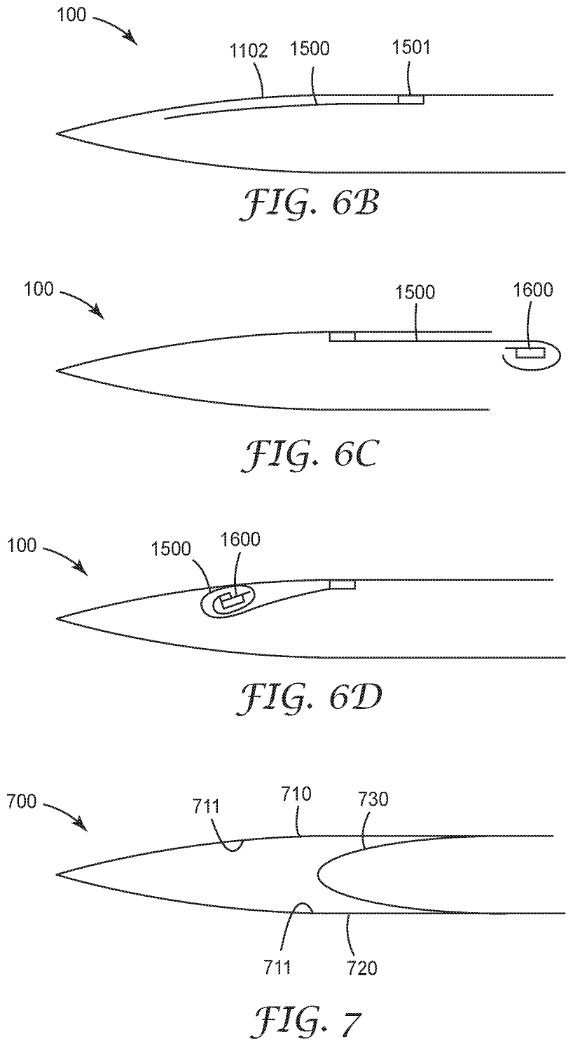

The containers as described herein feature the one or more deployable cushioning sheet connected to at least the first wall of the container. One example of this is shown in FIGS. 6A, 6B, and 6C. FIG. 6A shows container 100, having deployable cushioning sheet 1500 connected thereto. FIG. 6B shows that deployable cushioning sheet 1500, which can be any deployable cushioning sheet described herein, is connected first wall interior major surface 1102 by way of adhesive 1501, which is here in the form of an adhesive strip. The adhesive can be any suitable type of adhesive; the type of adhesive that is suitable can be selected depending on the nature of the first wall and the deployable cushioning sheet 1500. Commonly used adhesives include acrylate adhesives and silicone adhesives. Repositionable adhesives can be particularly advantageous for some uses.

FIG. 6C shows the deployable cushioning sheet in a deployed position wherein a portion of the deployable cushioning sheet is disposed outside of the container, and being wrapped around object 1600, after which it can be replaced within the container (FIG. 6D).

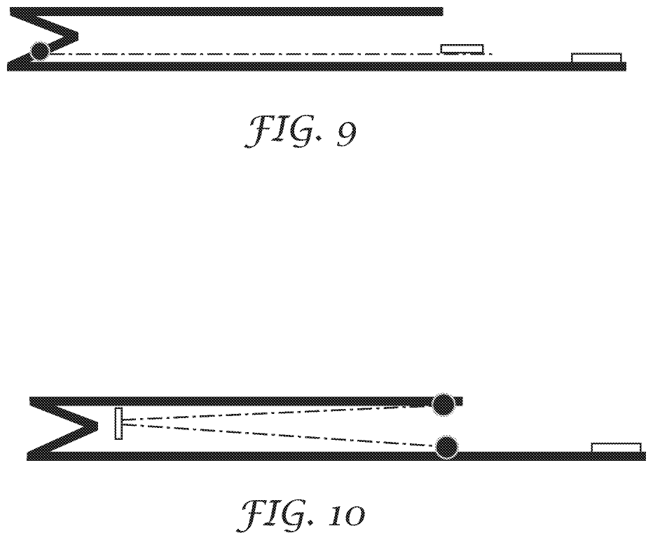

While FIGS. 6A-6D show deployable cushioning sheet 1500 connected at an edge that is near the opening of the container, it is also possible to connect deployable cushioning sheet 1500 to the container in another place, such as the edge that is farthest from the opening in the container. An example of a container having this configuration is shown in FIG. 9 and described in detail in the Examples Section.

FIG. 7 shows container 700 with first wall 710, second wall 720, and deployable cushioning sheet 730. In this FIG. 7, deployable cushioning sheet 730 is connected to the interior major surfaces 711 and 721 of first and second walls 710, 720, respectively. In this Figure, deployable cushioning sheet 730 is connected without adhesive, such as by lamination, such as thermal lamination, ultrasonic welding. It should be noted that just as adhesive can be used in a configuration as shown here, so could non-adhesive connections (lamination, such as thermal lamination, ultrasonic welding, or others) be used in any other configuration as well.

### Method of Making

The containers as described herein can be made by any known means, such as standard methods for making envelopes, mailers, boxes, or the like. The deployable cushioning sheet can be connected to the material that constitutes the container either before or after the container is formed, but usually before the container is formed into its final shape.

### Method of Using

The containers disclosed herein can be used to package an object. A typical use begins with deploying at least one of the one or more deployable cushioning sheets of a container as described herein. The deployable cushioning sheet is then contacted with the object, for example, by wrapping the deployable cushioning sheet around the object. The deployable cushioning sheet, with the object contacting it, is then replaced into the container. Optionally, when a flap is employed, the flap can be closed to seal the container. When the deployable cushioning sheet is a tension activated extendible sheet, the method can also include extending the tension activated extendible sheet.

### Composability and Recyclability

The containers are advantageously compostable, recyclable, or both. When recyclable, containers typically meet the Voluntary Standard for Repulping and Recycling Corrugated Fiberboard as promulgated by the Fibre Box Association (FBA) part 1 (repulpability). In addition, or in the alternative, the containers can meet the Voluntary Standard for Repulping and Recycling Corrugated Fiberboard as promulgated by the Fibre Box Association (FBA) part 2 (recyclability).

Particular recyclable containers also meet the ISO 18601 standard. Particular recyclable containers also meet the ISO 18604:2013 standard. Most particularly recyclable containers also meet both the ISO 18601 and the ISO 18604:2013 standards.

The containers may contain some components that are recycle-compatible rather than recyclable, in which case they are still considered to be recyclable. It is also possible for the containers to contain components, such as release liners (for example, for an adhesive on the flap, when employed), that are not recyclable but are designed to be removed from the containers before recycling. In such cases, the containers are still considered to be recyclable.

When the containers are compostable, they can meet the ASTM D6400 standard. Additionally, or in the alternative, when the containers are compostable they can mee the ASTM D6868 standard. In addition to meeting one or both of the aforementioned standards, compostable containers can meet at least one of the EN 12432 standard, the AS 4736 standard, or the ISO 17088 standard. Particular compostable containers also meet the ISO 14855 standard.

### EXAMPLES

The following examples illustrate particular aspects of the disclosure. Not every aspect of the disclosure is exemplified, so the examples should not be deemed limiting except where otherwise indicated. Unless otherwise noted, all parts, percentages, ratios, etc. in the examples and the rest of the specification are by weight, and all materials used in the examples were obtained, or are available, from general suppliers such as, for example, Georgia-Pacific, Atlanta, GA, US, unless otherwise specified. The following abbreviations are used herein: gsm=g/m²=grams per square meter, mm=millimeters, cm=centimeters, m=meters, in =inches, μm=microns=10⁻⁶ m, min=minutes, hr=hours, kg=kilograms, kPa=kilopascals, ° C.=degrees Celsius, ° F.=degrees fahrenheit.

### Sample Preparation

TABLE 1
Materials

| Material | Description | Supplier |
|---|---|---|
| BIOPBS FZ71 | Bio-based Polybutylene succinate | PTT MCC Biochem Company |
| | | Limited, Bangkok, Thailand |
| INGEO 6202D | Polylactide (PLA) biopolymer | Nature Works LLC, Minnetonka, |
| | | MN, USA |
| PLAM 69962 | PLA green masterbatch coloring | Techmer PM LLC, Clinton, TN, |
| | | USA |
| OM93642451 | PLA black masterbatch coloring | Clariant Corporation, Minneapolis |
| | | MN, USA |
| OM0364246 | PLA white masterbatch coloring | Clariant Corporation Minneapolis |
| | | MN, USA |
| Kraft Paper | 73 gsm basis weight natural Kraft | Ahlstrom Munksjo, Kaukauna, WI, |
| #064450 | paper | USA |
| S-7051 | 125 gsm basis weight brown paper | Uline, Pleasant Prairie, WI, USA |
| Kraft Paper | 125 gsm basis weight recycled kraft | Liberty Paper Inc, Becker MN, USA |
| | paper that is marked by the | |
| | manufacturer as “26 pound” weight | |
| 9925XL | Double Coated Tape with Liner | 3M Company, Maplewood, MN, USA |

### Examples 1A-1J

45-pound Kraft paper was undercoated by melt extrusion of the coating material using a 58-mm twin screw extruder (obtained under the trade designation “DTEX58” from Davis-Standard, Pawcatuck, CT, USA), operated at a 260° C. extrusion temperature, with a heated hose (260° C.) leading to a 760 mm drop die (obtained from Cloeren, Orange, TX, USA) with 686 mm deckles, a 0-1 mm adjustable die lip, and a single layer feed-block system. Solid coating material was fed at a rate of 22.7 kg/hr into the twin-screw system at the conditions described above. The resultant molten resin formed a thin sheet as it exited the die and was cast onto the paper. The surface roughness was set at 75 Roughness Average by use of a sleeve (available from American Roller, Union Grove, WI, USA) against the coated side of the paper, and a silicone rubber nip roll (80-85 durometer; from American Roller) was against the opposite side. The layered composite was pressed between the two nip rolls with a nip force of about 70 KPa, at a line speed that was adjusted to provide the desired coating thickness. One side was coated with an undercoat composition of 90% BioPBS FZ71 and 10% PLAM 69962 at 42 microns at a thickness of 42 μm.

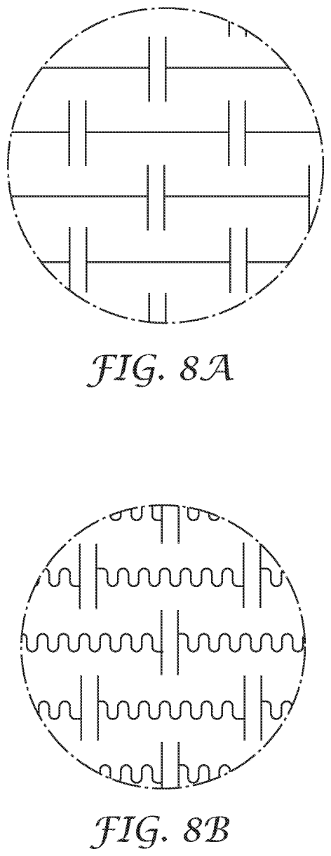

Sheets of the deployable cushioning layer were prepared using S-7051 paper, which was made from 100% recycled paper with a basis weight of about 125 g/m² when measured according to test method TAPPI T410 om-13 (provided by the Technical Association of the Pulp and Paper Industry (TAPPI), Atlanta, GA, USA), a thickness of about 0.19 mm (0.0075 in) when measured according to test method TAPPI T411 om-10, a tear strength when measured according to test method T414 om-12 of about 100 g/ply in the machine direction and about 135 g/ply in the cross direction. The pattern of slits shown in FIG. 8A were cut into the paper using a rotary die cutting method using custom-made, flexible rotary dies made specifically for the pattern in FIG. 8A. The die had a blade angle of 74.00 degrees and a cylinder undercut of 0.61 mm (0.0240 in). The flexible die was mounted onto a magnetic cylinder, held in a frame, and pressed against a blank die with sufficient force to fully cut through the paper. The process details required to convert thin material sheets with rotary converting are well known across multiple industries and many suppliers exist who can manufacture the dies and many companies exist who can run the dies on equipment to produce converted material. A paper strip was adhered to one edge of the sheet (perpendicular to the tension axis of the expandable sheet) using a heat sealable adhesive, to form a pull tab. In these examples, the edge of the sheet containing the pull tab will be referred to as the “top edge,” the edge opposite the top edge is referred to as the “bottom edge” and the remaining edges are called the “side edges.”

To form the container for Example 1A, a sheet of Kraft paper having initial dimensions of approximately 28 cm (11 in) wide by 61 cm (24 in) long was folded to form an overlapping area approximately 28 cm (11 in) wide and 27.3 cm (10.75 in) long, with a protruding flap that was about 6.4 cm (2.5 in) long. The coated paper was oriented such that the undercoated side was on the inside. A sheet of deployable cushioning paper (25.4 cm (10 in) wide by 35.5 cm (14 in) long) was placed inside the folded Kraft paper so that the top edge of the cushioning paper was nearest the flap end. This structure was then heat sealed around three edges using a model H-458 manual impulse sealer (available from Uline, Pleasant Prairie, WI, USA) set at 299° C. (570° F.) for 0.5 secs at a pressure of 345 kPa (50 psi) to form a flat package with an opening at the flap end. The seal line was about 6 mm (0.25 in) wide. The seal line anchored the bottom edge of the deployable cushioning layer to the edge of the package opposite the opening. The remaining edges of the deployable cushioning layer were not attached to the package.

Example 1B was prepared similarly to Example 1A except that the deployable cushioning layer was made as follows. Sheets of the deployable cushioning layer were prepared using 26-pound Kraft paper, which was made from 100% recycled paper with a basis weight of about 125 g/m² when measured according to test method TAPPI T410 om-13 (provided by the Technical Association of the Pulp and Paper Industry (TAPPI), Atlanta, GA, USA), a thickness of about (0.19 mm) (0.0073 in) when measured according to test method TAPPI T411 om-10, a tear strength when measured according to test method T414 om-12 of about 116 g/ply in the machine direction and about 138 g/ply in the cross direction. The pattern of slits shown in FIG. 8B were cut into the paper using a rotary die cutting method using custom-made, flexible rotary dies made specifically for the pattern in FIG. 8B, and the procedures described for Example 1A.

Example 1C was prepared similarly to Example 1A with the following changes. After the sheet of Kraft paper was folded roughly in half, a portion near the fold was folded inward to form a V-shaped gusset, as shown in FIG. 9. The bottom edge of the deployable cushioning layer was placed between the side of the Kraft paper pouch and the gusset, as shown in FIG. 9. The layered structure was then heat sealed around three edges using the manual impulse sealer and conditions provided for Example 1A. The seal line anchored the bottom edge of the deployable cushioning layer to the gusset on the bottom of the package, and the remaining edges of the cushioning layer remained unattached.

Example 1D was prepared similarly to Example 1C except that the deployable cushioning layer was cut into the pattern of slits shown in FIG. 8B using custom-made, flexible rotary dies made specifically for the pattern in FIG. 8B, using the materials and description for Example 1B.

Example 1E was prepared similarly to Example 1C with the following changes. Prior to edge sealing, the deployable cushioning layer was folded into three layers with the bottom edges and top edges protruding slightly. Again, the bottom edge of the deployable cushioning layer was placed in between one side of the folded coated Kraft paper and one side gusset and the layered structure was then heat sealed around three edges using the manual impulse sealer and conditions described above. The seal line anchored the bottom edge of the deployable cushioning layer to the gusset on the bottom of the package, and the remaining edges of the cushioning layer remained unattached.

Example 1F was prepared similarly to Example 1E except that the deployable cushioning layer was cut into the slit pattern in FIG. 8B, using the materials and process described for Example 1B.

Example 1G was prepared similarly to Example 1E, except that the bottom edge of the deployable cushioning layer was placed along the inside of one side of the folded coated Kraft paper roughly midway between the gusset and the opening, rather than against the gusset. The bottom edge of the deployable cushioning layer was heat sealed to the Kraft paper using the manual impulse sealer and conditions described above, then the package was heat sealed along the side edges to form a package with an opening and a flap. A seal line anchored the bottom edge of the deployable cushioning layer to the side of the package, and the remaining edges of the cushioning layer remained unattached to the package.

Example 1H was prepared similarly to Example 1G except that the deployable cushioning layer was cut using custom-made, flexible rotary dies made specifically for the slit pattern in FIG. 8B, using the materials and process described for Example 1B.

Example 1I was prepared similarly to Example 1C with the following modifications. Two sheets of the deployable cushioning layer were used. The bottom edge of one deployable cushioning sheet was placed in between one side of the folded coated Kraft paper and one side of the gusset fold, and the bottom edge of the other deployable cushioning sheet was placed in between the other side of the gusset and the other side of the folded paper pouch. The layered structure was then heat sealed around three edges using the manual impulse sealer and conditions described above. The seal line anchored the bottom edges of the deployable cushioning layers to the gusset on the bottom of the package, and the remaining edges of the cushioning layer remained unattached.

Example 1J was prepared similarly to Example 1I except that the deployable cushioning layer was cut using custom-made, flexible rotary dies made specifically for the slit pattern in FIG. 8B, using the materials and process described for Example 1B.

### Examples 2A-2J

A dual-layer web of spunbond nonwoven fabric was prepared using INGEO 6202D PLA according to the general method disclosed in U.S. Pat. No. 3,802,817. The apparatus included a first station and a second station, each including an extrusion head, an attenuator, and a quenching stream. Both stations shared a collector surface. The INGEO 6202D was melted in the first extruder of the first station and pumped into an extrusion head that included multiple orifices arranged in rows of straight lines. Filaments were formed in a core/sheath configuration; even though the core and sheath were both made from INGEO 6202D PLA, a boundary existed between the two concentric layers to form a core and a sheath. Quenching streams of air were directed toward the extruded filaments, which were passed through the attenuator then deposited onto a generally flat collector surface to form a first mass of fibers (first nonwoven layer). Filaments produced by the second station were deposited on the surface of the first fiber mass on the collector as a second nonwoven layer.

Specific processing conditions were as follows. The first nonwoven layer was made by first extruding INGEO 6202D PLA sheath/core filaments at temperatures of 200° C. to 230° C. (sheath) and 230° C. (core), which were then drawn by a quenching air stream at 10° C. and flowrates of 23 m³/min in Zone 1 and 23 m³/min in Zone 2. A second layer of INGEO 6202D PLA monocomponent filaments were extruded at 230° C., then drawn by quench air at 15° C. and a flow rate of 12 m³/min and were laid on the first composite layer to form a dual-layer web. The dual-layer web was then passed through a through-air bonding station (i.e., were autogenously bonded), where hot air of 100° C.-125° C.-130° C. was blown on the dual-layer web to thermally bond the layers. Web speed was adjusted to obtain the desired basis weight of 30 gsm.

The INGEO 6202D PLA web was coated by melt extrusion of the coating material using a 58-mm twin screw extruder (obtained under the trade designation “DTEX58” from Davis-Standard, Pawcatuck, CT, USA), operated at a 260° C. extrusion temperature, with a heated hose (260° C.) leading to a 760 mm drop die (obtained from Cloeren, Orange, TX, USA) with 686 mm deckles, a 0-1 mm adjustable die lip, and a single layer feed-block system. Solid coating material was fed at a rate of 22.7 kg/hr into the twin-screw system at the conditions described above. The resultant molten resin formed a thin sheet as it exited the die and was cast onto the web. The surface roughness was set at 75 Roughness Average by use of a sleeve (available from American Roller, Union Grove, WI, USA) against the cast film side, and a silicone rubber nip roll (80-85 durometer; from American Roller) was against the spunbond side. The layered composite was pressed between the two nip rolls with a nip force of about 70 KPa, at a line speed that was adjusted to provide the desired coating thickness. One side was coated with a topcoat composition of 90 wt % BioPBS FZ71 and 10% PLAM 69962 at a thickness of 42 μm, and the other side was coated with an undercoat composition of 90% PBS FZ71, 5% OM0364246 PLA white masterbatch, and 5% OM93642451 PLA Black masterbatch on the inner side at a thickness of 42 μm.

To form the container for Example 2A, the coated PLA nonwoven fabric having initial dimensions of approximately 28 cm (11 in) wide by 128 cm (50.5 in) long was folded to form an overlapping area 28 cm (11 in) wide and 61 cm (24 in) long, with a protruding flap that was about 6.4 cm (2.5 in) long. The coated nonwoven was oriented such that the undercoated side was on the inside. A deployable cushioning layer was prepared as described for Example 1A using the slit pattern shown in FIG. 8A, and was placed inside the folded PLA nonwoven fabric so that the top edge of the cushioning paper was nearest the flap end. This layered structure was then heat sealed around three edges to form a flat package with an opening and a flap, using the manual impulse sealer and conditions described above for Example 1A. The seal line was about 6 mm (0.25 in) wide. The seal line anchored the bottom edge of the deployable cushioning layer to the edge of the package opposite the opening. The remaining edges of the deployable cushioning layer were not attached to the package.

Example 2B was prepared similarly to Example 2C except that the deployable cushioning layer was cut using custom-made, flexible rotary dies made specifically for the slit pattern in FIG. 8B, using the materials and process described for Example 1B.

Example 2C was prepared similarly to Example 2A with the following changes. After the sheet of PLA nonwoven was folded roughly in half, a portion near the fold was folded inward to form a V-shaped gusset, as described for Example 1C. The bottom edge of the deployable cushioning layer was placed between the side of the PLA nonwoven pouch and the gusset. The layered structure was then heat sealed around three edges using the manual impulse sealer and conditions provided for Example 1A. The seal line anchored the bottom edge of the deployable cushioning layer to the gusset on the bottom of the package, and the remaining edges of the cushioning layer remained unattached.

Example 2D was prepared similarly to Example 2C except that the deployable cushioning layer was cut using custom-made, flexible rotary dies made specifically for the slit pattern in FIG. 8B, using the materials and process described for Example 1B.

Example 2E was prepared similarly to Example 2C with the following changes. Prior to edge sealing, the deployable cushioning layer was folded into three layers, with the bottom edges and top edge protruding slightly. Again, the bottom edge of the deployable cushioning layer was placed in between one side of the coated nonwoven and one side of the gusset and the layered structure was then heat sealed around three edges using the manual impulse sealer and conditions described above. The seal line anchored the bottom edge of the deployable cushioning layer to the gusset on the bottom of the package, and the remaining edges of the cushioning layer remained unattached.

Example 2F was prepared similarly to Example 2E except that the deployable cushioning layer was cut using custom-made, flexible rotary dies made specifically for the slit pattern in FIG. 8B, using the materials and process described for Example 1B.

Example 2G was prepared similarly to Example 2E, except that the bottom edge of the deployable cushioning layer was placed along the inside of one side of the folded nonwoven sheet, roughly midway between the gusset and the opening, rather than against the gusset. The bottom edge of the deployable cushioning layer was heat sealed to nonwoven sheet using the manual impulse sealer and conditions described above, then the package was heat sealed along the side edges to form a package with an opening and a flap. A seal line anchored the bottom edge of the deployable cushioning layer to the side of the package, and the remaining edges of the cushioning layer remained unattached to the package.

Example 2H was prepared similarly to Example 2G except that the deployable cushioning layer was cut using custom-made, flexible rotary dies made specifically for the slit pattern in FIG. 8B, using the materials and process described for Example 1B.

Example 2I was prepared similarly to Example 2C with the following changes. Two sheets of the deployable cushioning layer were used. The bottom edge of one deployable cushioning sheet was placed in between one side of the coated nonwoven pouch and one side of the gusset and the bottom edge of the other deployable cushioning sheet was placed in between the other side of the gusset and the other side of the coated nonwoven pouch. The layered structure was then heat sealed around three edges using the manual impulse sealer and conditions described above. The seal line anchored the bottom edges of the deployable cushioning layers to the gusset on the bottom of the package, and the remaining edges of the cushioning layer remained unattached.

Example 2J was prepared similarly to Example 2G except that the deployable cushioning layer was cut using custom-made, flexible rotary dies made specifically for the slit pattern in FIG. 8B, using the materials and process described for Example 1B.

### Examples 3A-3D

Coated sheets of 45-pound Kraft paper were prepared as described for Example 1A. Sheets of expandable cushioning paper (each 25.4 cm (10 in) wide by 35.5 cm (14 in) long), with the tension axis oriented parallel to the long end) were prepared as described for Example 1A, except that the paper strips were adhered to the center of each sheet rather than the end, again oriented perpendicular to the tension axis. The sheets of expandable cushioning paper were folded in half roughly parallel to the paper strips and close to the strips to form a dual layer insert roughly 30.5 cm (12 in) wide by 18.4 cm (7.25 in) long.

To form the package for Example 3A, a sheet of Kraft paper having initial dimensions of approximately 31.8 cm (12.5 in) wide by 61.0 cm (24 in) long was folded to form an overlapping area 31.8 cm (12.5 in) wide by and 28 cm (11 in) long, with a protruding flap that was about 5 cm (2 in) long. As described for Example 1C, the paper was folded inward to form a V-shaped gusset. The coated paper was oriented such that the undercoated side was on the inside. The folded deployable cushioning layer was inserted into the paper container such that it aligned with the opening of the container. The container was then heat sealed along the side edges using the manual impulse sealer and sealing conditions described earlier to form a gusseted package with an opening and a flap. Additional seal lines were added along the opening of the package to anchor the ends of the sheet of expandable cushioning material as shown in FIG. 10. Each seal line was about 6 mm (0.25 in) wide. The side edges of the deployable cushioning layer were not attached to the package and formed a concave “hammock” configuration within the package, with the paper strip along the bottom.

Example 3B was prepared similarly to Example 3A except that the deployable cushioning layer was cut using custom-made, flexible rotary dies made specifically for the slit pattern in FIG. 8B, using the materials and process described for Example 1B.

Example 3C was prepared similarly to Example 3A, except that the Kraft paper was not folded to form a gusset, thus forming a flat package.

Example 3D was prepared similarly to Example 3C except that the deployable cushioning layer was cut using custom-made, flexible rotary dies made specifically for the slit pattern in FIG. 8B, using the materials and process described for Example 1B.

### Examples 4A-4D

Double-coated sheets of PLA nonwoven were prepared as described for Example 2A and sheets of expandable cushioning paper were prepared and folded as described for Example 3A.

To form the package for Example 4A, a sheet of coated PLA nonwoven having initial dimensions of approximately 28 cm (11 in) wide by 128 cm (50.5 in) long was folded to form an overlapping area 28 cm (11 in) wide and 61 cm (24 in) long, with a protruding flap that was about 6.4 cm (2.5 in) long. As described for Example 1C, the nonwoven was folded inward to form a V-shaped gusset. The coated nonwoven was oriented such that the undercoated side was on the inside. This layered structure was then heat sealed along the side edges using the manual impulse sealer and sealing conditions described earlier to form a gusseted package with an opening and a flap. As described for Example 3A, the folded deployable cushioning layer was inserted into the paper container such that it aligned with the opening of the container and additional seal lines were added along the opening of the package to anchor the ends of the sheet of expandable cushioning material. Each seal line was about 6 mm (0.25 in) wide. The side edges of the deployable cushioning layer were not attached to the package and formed a concave “hammock” configuration within the package, with the paper strip along the bottom.

Example 4B was prepared similarly to Example 4A except that the deployable cushioning layer was cut into the slit pattern in FIG. 8B, using the materials and process described for Example 1B.

Example 4C was prepared similarly to Example 4A, except that the folded PLA nonwoven gusset was not folded to form a gusset, thus forming a flat package.

Example 4D was prepared similarly to Example 4C except that the deployable cushioning layer was cut into the slit pattern in FIG. 8B, using the materials and process described for Example 1B.

### Examples 5A-5D

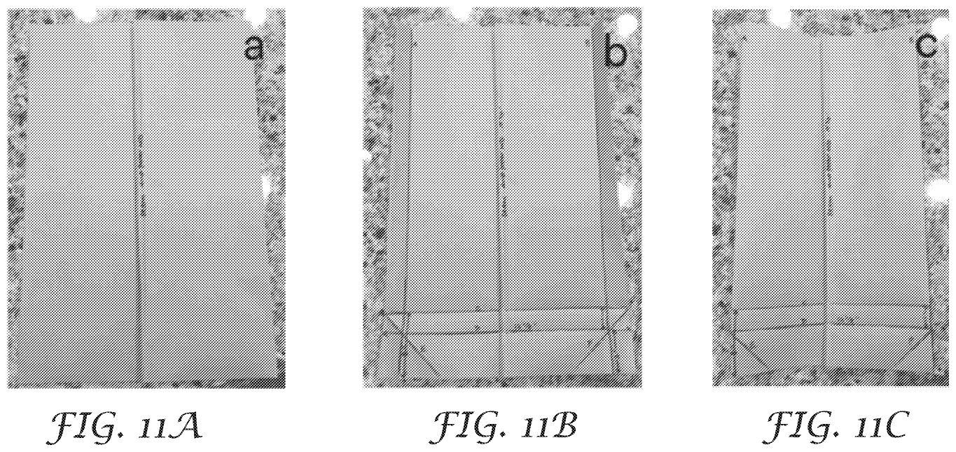

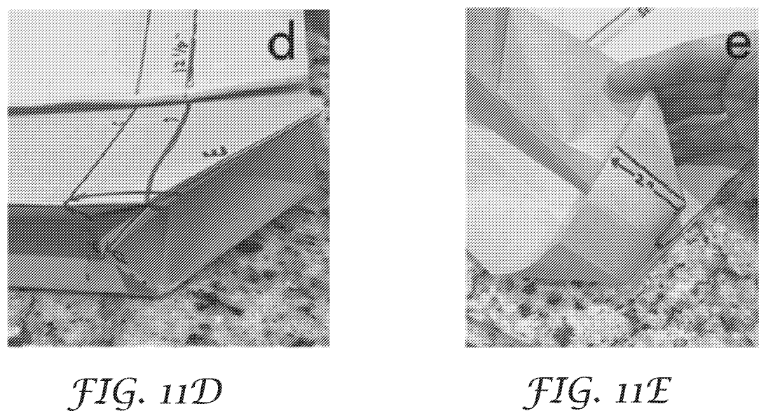

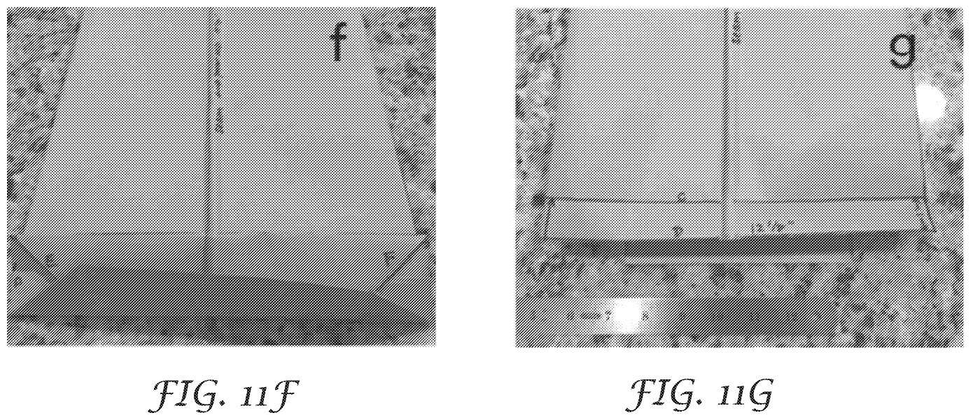

Coated sheets of 45-pound Kraft paper measuring approximately 61 cm (24 in) wide by 47 cm (18.5 in) long were prepared as described for Example 1A. Containers having gussets on three sides were made from the coated paper sheets as shown in FIGS. 11A-G. The material was folded lengthwise and the seam was heat sealed to form a flattened tube with a center seam, as shown in FIG. 11A. The face of the mailer that includes the seam is referred to as the “front” and the opposite face is referred to as the “back.” Six creases denoted A-F were made as shown in FIG. 11B. Creases A and B were folded inward to from V-shaped side gussets as shown in FIG. 11C. Creases C and D were folded towards the front side. As shown in FIG. 11D, the sides of crease D were bent outward to form points on each side, which caused creases E and F to fold inward and form an angular section on the front and back of the mailer. Then crease D was opened towards the front side as shown in FIG. 11E. As shown in Figure F, the front flap was folded down along crease D and the back flap was folded upward along crease D. The gusset was reversed to face the back side of the mailer and sealed using the impulse sealer and conditions described above for Example 1A to form a bottom gusset. A trimmer was used to remove the seam side flap. On the back side of the container near the open side, a section was removed along creases A and B and to form a 3.2 cm (1.25 in) flap along the opening. A strip of 9925XL tape was applied to the flap approximately 0.95 cm (0.375 in) from the edge, and the release liner remained on the adhesive strip.

For Example 5A, a deployable cushioning layer was prepared as described for Example 1A using the slit pattern shown in FIG. 8A and was placed inside one of the paper containers such that the top edge of the cushioning paper was nearest the opening. Using the manual impulse sealer and conditions described above, the bottom edge of the deployable cushioning layer was anchored to the bottom gusset of the container. The remaining edges of the deployable cushioning layer were not attached to the package.

Example 5B was identical to Example 5A except that the deployable cushioning layer was cut into the slit pattern in FIG. 8B.

For Example 5C, a sheet of expandable cushioning paper were prepared and folded as described for Example 3A. The ends of the sheet of expandable cushioning material were sealed to the front and back portions of the opening of the package to form a concave “hammock” configuration within the package, with the paper strip along the bottom, as described for Example 3A.

Example 5D was identical to Example 5C except that the deployable cushioning layer was cut into the slit pattern in FIG. 8B.

1. A container comprising
a container interior at least partially defined by
a first wall comprising a first wall interior major surface and opposing first wall exterior major surface, and
a second wall comprising a second wall interior major surface and opposing second wall exterior major surface; and
one or more deployable cushioning sheets that are connected to the first wall interior major surface and that have a length, wherein
the one or more deployable cushioning sheets are configured to be deployable from a first position to a second position, wherein
in the first position a first portion of the length of the one or more deployable cushioning sheets is disposed within the container interior and an optional second portion of the length of the one or more deployable cushioning sheets is disposed outside the container interior, and
in the second position at least part of the first portion of the length is disposed outside of the container,
wherein the one or more deployable cushioning sheets comprise one or more tension activated expandable sheets.

2. The container of claim 1, further comprising a container opening and wherein the one or more deployable cushioning sheets are deployable such that at least a portion of the length of the one or more deployable cushioning sheets can be moved through the container opening when the one or more deployable cushioning sheets are deployed from the first position to the second position.

3-33. (canceled)

34. The container of claim 1, wherein the one or more tension activated expandable sheets comprise paper.

35. The container of claim 1, wherein the one or more deployable cushioning sheets comprise one or more foam components.

36. The container of claim 1, wherein the one or more deployable cushioning sheets comprises one or more paper sheets.

37. The container of claim 36, wherein the one or more paper sheets are embossed.

38. The container of claim 1, wherein the one or more deployable cushioning sheets comprise cardboard, optionally corrugated cardboard.

39. The container of claim 1, further comprising an adhesive that connects at least one of the one or more deployable cushioning sheets to the first wall interior major surface.

40. The container of claim 39, wherein the adhesive is a repositionable adhesive.

41. The container of claim 1, wherein at least one of the one or more deployable cushioning sheets are welded to the first wall interior major surface.

42. The container of claim 1, wherein at least one of the one or more deployable cushioning sheets are laminated to the first wall interior major surface.

43. The container of claim 1, wherein at least one of the one or more deployable cushioning sheets are connected to the second wall interior surface.

44. The container of claim 1, further comprising an adhesive that connects at least one of the one or more deployable cushioning sheets to the second wall interior major surface.

45. The container of claim 44, wherein the adhesive is a repositionable adhesive.

46. The container of claim 1, wherein at least one of the one or more deployable cushioning sheets are welded to the second wall interior major surface.

47. The container of claim 1, wherein at least one of the one or more deployable cushioning sheets are laminated to the second wall interior major surface.

48-59. (canceled)

60. A method of packaging an object, comprising
deploying at least one of the one or more deployable cushioning sheets of a container of claim 1;
contacting the least one of the one or more deployable cushioning sheets with the object; and
placing the least one of the one or more deployable cushioning sheets with the contacted object inside the container,
wherein the one or more deployable cushioning sheets comprise one or more tension activated expandable sheets.

61. The method of claim 60, further comprising wrapping the one or more deployable cushioning sheets around the object.

62. The method of claim 60, further comprising sealing the opening of the container with a flap.

63. The method of claim 60,
wherein the step of deploying least one of the one or more deployable cushioning sheets comprises extending the tension activated extensible sheet.
